(19) United States
(12) Patent Application Publication
(10) Pub. No.: US 2026/0169411 A1
(43) Pub. Date: Jun. 18, 2026

(54) CHARGE REMOVAL APPARATUS AND IMAGE FORMING SYSTEM

(71) Applicant: CANON KABUSHIKI KAISHA, Tokyo (JP)

(72) Inventors: HIROYUKI EDA, Ibaraki (JP); TOSHIFUMI OIKAWA, Ibaraki (JP); HIROKI KOBAYASHI, Ibaraki (JP); KAZUHIRO AKIBA, Chiba (JP)

(21) Appl. No.: 19/418,049

(22) Filed: Dec. 12, 2025

(30) Foreign Application Priority Data
Dec. 17, 2024 (JP) 2024-220509

(51) Int. Cl. G03G 15/00; B65H 37/00

(52) U.S. Cl. CPC G03G 15/55; B65H 37/00; G03G 15/5012; G03G 15/5016; G03G 15/6573; B65H 2301/5133; G03G 2215/00417

(57) ABSTRACT

An image forming system includes an image forming unit, a noncontact charge-removal unit, a controller, and a display unit. The image forming unit forms an image on a sheet. The noncontact charge-removal unit removes a charge on the sheet, on which the image has been formed, in a noncontact state. The noncontact charge-removal unit includes an electrode portion that generates an ion. The controller performs a detection process of detecting whether maintenance of the electrode portion is necessary. The display unit indicates that the detection process is being performed.

### BACKGROUND

### Field of the Technology

The present disclosure relates to a charge removal apparatus and an image forming system.

### Description of the Related Art

In an image forming apparatus that forms images on sheets, sheets may be electrostatically charged when images are formed on the sheets, and the ejected sheets may be stuck to each other, resulting in stacking failure. Accordingly, an image forming system including a noncontact charge-removal unit that removes charges on sheets in a noncontact state has been proposed.

When a noncontact charge-removal unit is continuously used, dust or organic matter in the air may be deposited on electrode portions of the noncontact charge-removal unit, resulting in deterioration of charge removal performance of the noncontact charge-removal unit. Therefore, the noncontact charge-removal unit is desirably maintained at appropriate times. Japanese Patent Laid-Open No. 2024-107617 describes that, when the number of sheets, which are subjected to charge removal by the noncontact charge-removal unit, reaches a threshold, a detection process of detecting whether maintenance of the electrode portions of the noncontact charge-removal unit is necessary is performed.

However, a user's operation may cause unintentional interruption of a detection process of detecting whether maintenance of a noncontact charge-removal unit is necessary. In this case, nonexecution of the detection process of the noncontact charge-removal unit may cause attachment of sheets due to deterioration of charge removal performance.

### SUMMARY

Therefore, embodiments of the present disclosure are directed to provide a charge removal apparatus and an image forming system with a reduced possibility of unintentional interruption of a detection process of detecting whether maintenance of a noncontact charge-removal unit is necessary.

According to an aspect of the present disclosure, there is provided an image forming system comprising an image forming unit that forms an image on a sheet; a noncontact charge-removal unit that removes a charge on the sheet, on which the image has been formed, in a noncontact state, the noncontact charge-removal unit including an electrode portion that generates an ion; a controller that performs a detection process of detecting whether maintenance of the electrode portion is necessary; and a display unit that indicates that the detection process is being performed.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system.

FIG. 2 is a schematic diagram illustrating a charge removal apparatus.

FIG. 3 is a diagram illustrating the image forming system.

FIG. 4 is a perspective view of an upper unit and a lower unit in a state in which the upper unit is closed.

FIG. 5 is a perspective view of an upper unit and a lower unit in a state in which the upper unit is opened.

FIG. 6 is a perspective view of a transport guide of a noncontact charge-removal unit.

FIG. 7 is a block diagram illustrating control of the image forming apparatus and the charge removal apparatus.

FIG. 8A is a diagram illustrating a screen displayed in a state in which a print job is ready to be received for execution.

FIG. 8B is a diagram illustrating a screen displayed during execution of a maintenance-necessity detection operation.

FIG. 8C is a diagram illustrating a screen with an advance notice of a maintenance-necessity detection operation.

FIG. 8D is a diagram illustrating a screen with a notice of the result of a maintenance-necessity detection operation.

FIG. 9 is a flowchart of control of a charge-removal controller according to a first embodiment.

FIG. 10 is a flowchart of control of a maintenance-necessity detection operation according to the first embodiment.

FIG. 11 is a flowchart of control of a charge-removal controller according to a second embodiment.

FIG. 12 is a flowchart of control of an image forming apparatus according to a third embodiment.

FIG. 13 is a flowchart of control of a charge-removal controller according to the third embodiment.

FIG. 14 is a flowchart of control of a maintenance-necessity detection operation according to the third embodiment.

FIG. 15 is a diagram illustrating a screen of a user operation unit according to the third embodiment.

### DESCRIPTION OF THE EMBODIMENTS

Embodiments of the present disclosure will be described below with reference to the drawings. The sizes, materials, relative positions, and the like of components of an image forming apparatus and a charge removal apparatus are not intended to limit the scope of the present disclosure only to these unless otherwise specified. In the drawings, components designated with the same reference numeral have the same configuration or operation, and repeated description about these is avoided as appropriate.

### First Embodiment

### Schematic Configuration of Image Forming Apparatus

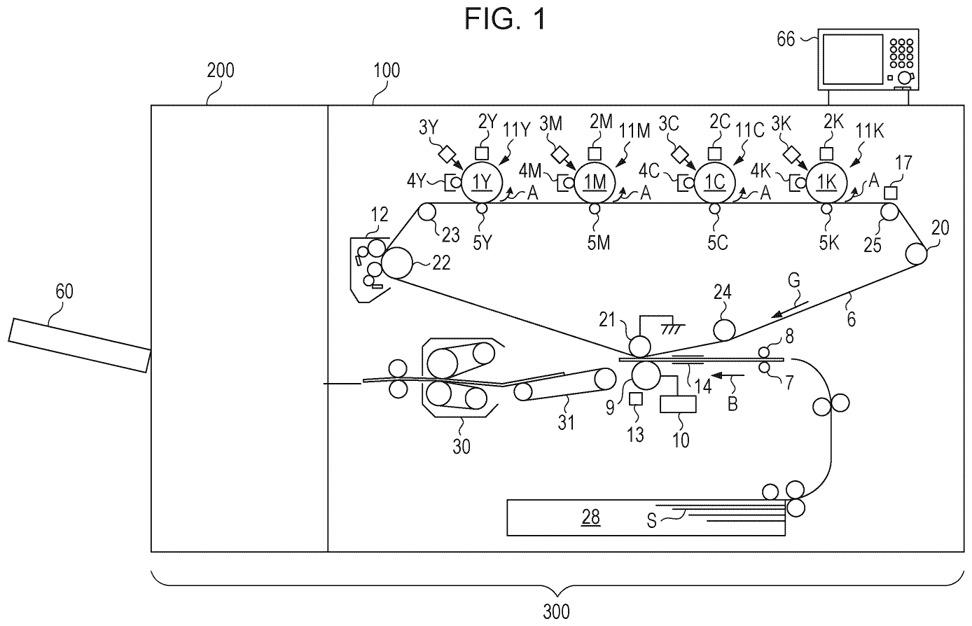

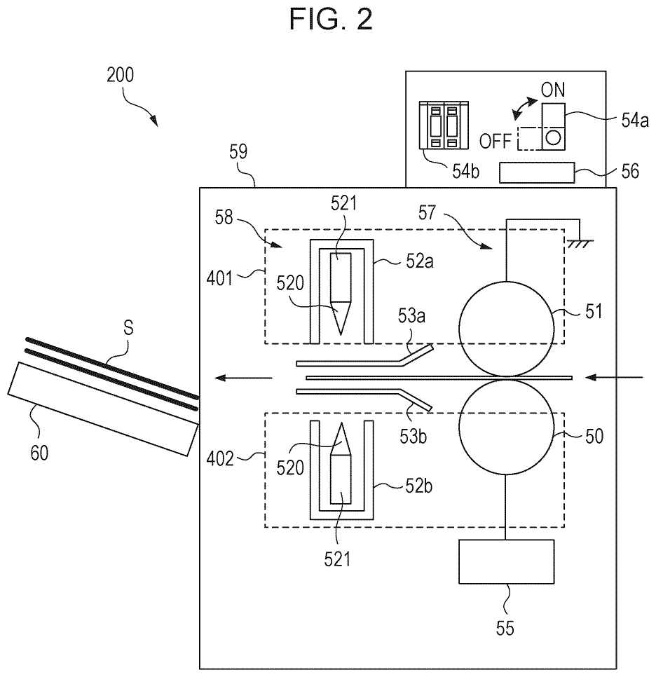

FIG. 1 is a configuration diagram of an image forming system 300 according to a first embodiment. The image forming system 300 includes an image forming apparatus 100, which forms an image on a sheet S, and a charge removal apparatus 200, which removes charges on the sheet surfaces. The schematic diagram of the image forming system 300 in FIG. 1 does not illustrate the details of the charge removal apparatus 200. The configuration of the charge removal apparatus 200 will be described later (see FIG. 2).

The schematic configuration of the image forming apparatus 100 will be described first. The image forming apparatus 100 uses an electrophotographic process to form an image on a sheet. The image forming apparatus 100 has four image forming units 11Y, 11M, 11C, and 11K, which form images of yellow (Y), magenta (M), cyan (C), and black (K), respectively, as image forming units. The image forming units 11Y, 11M, 11C, and 11K are disposed in a row in the moving direction of an image transfer surface disposed substantially horizontally on an intermediate transfer belt 6 described later. The image forming units 11 have photoconductive drums 1 (1Y, 1M, 1C, and 1K), charging devices 2 (2Y, 2M, 2C, and 2K), exposure devices 3 (3Y, 3M, 3C, and 3K), developing devices 4 (4Y, 4M, 4C, and 4K), and primary transfer rollers 5 (5Y, 5M, 5C, and 5K).

As illustrated in FIG. 1, the photoconductive drums (latent image carriers) 1Y, 1M, 1C, and 1K rotate in the arrow A direction. The surfaces of the photoconductive drums 1Y, 1M, 1C, and 1K are electrostatically charged uniformly by the charging devices 2Y, 2M, 2C, and 2K. The exposure devices 3Y, 3M, 3C, and 3K perform exposure on the basis of image information to form electrostatic latent images on the surfaces of the photoconductive drums 1Y, 1M, 1C, and 1K. The developing devices 4Y, 4M, 4C, and 4K contain color toners of yellow (Y), magenta (M), cyan (C), and black (K), respectively. The developing devices 4Y, 4M, 4C, and 4K develop electrostatic latent images with the respective toners so that toner images are formed on the surfaces of the photoconductive drums 1Y, 1M, 1C, and 1K.

In the first embodiment, the image forming apparatus 100 employs a reversal developing system in which toner is deposited, for development, in exposure regions of an electrostatic latent image.

The intermediate transfer belt 6 is disposed so as to be in contact with the surfaces of the photoconductive drums 1Y, 1M, 1C, and 1K. The intermediate transfer belt 6 is stretched around stretch rollers 20, 21, 22, 23, 24, and 25, and rotates at a rotational speed of 150 to 470 mm/sec in the arrow G direction. In the first embodiment, the stretch roller 20 is a tension roller controlled so that the tensile force of the intermediate transfer belt 6 is constant. The stretch roller 22 is a driving roller of the intermediate transfer belt 6. The stretch roller 21 is an inside roller for secondary transfer. An outside roller 9 for secondary transfer pinches, for transportation, a sheet S by using a secondary transfer nip (secondary transfer portion) with the intermediate transfer belt 6.

The primary transfer rollers 5Y, 5M, 5C, and 5K are disposed opposite the photoconductive drums 1Y, 1M, 1C, and 1K, respectively, with the intermediate transfer belt 6 interposed therebetween, and form primary transfer nips (primary transfer portions) with the photoconductive drums 1Y, 1M, 1C, and 1K, respectively. In synchronization with color toner images on the surfaces of the photoconductive drums 1Y, 1M, 1C, and 1K being transported to the primary transfer nip portions, constant-voltage-controlled transfer biases of the polarity opposite to that of the toner images are applied to the primary transfer rollers 5Y, 5M, 5C, and 5K. Thus, the toner images on the photoconductive drums 1Y, 1M, 1C, and 1K are transferred onto the intermediate transfer belt 6 (primary transfer).

An on-belt image reading sensor 17 is disposed close to the intermediate transfer belt 6. The on-belt image reading sensor 17 reads an image which has been transferred onto the intermediate transfer belt 6. The on-belt image reading sensor 17, which is, for example, an optical sensor, emits light onto the image on the intermediate transfer belt 6, and receives the reflected light to read the image. For example, the on-belt image reading sensor 17 reads an adjustment image which is used to adjust an image forming condition and which is formed on the intermediate transfer belt 6. A main-body CPU 61, which is described later, analyzes the reading result of the adjustment image obtained by the on-belt image reading sensor 17, and feeds back, for calibration, to the image forming condition.

A sheet S stored in a cassette 28 is transported to a registration roller 8 by using feed rollers or the like, and is stopped temporarily. In synchronization with the toner images on the intermediate transfer belt 6 being transported to the secondary transfer nip, the registration roller 8 transports the sheet S to the secondary transfer portion. A pre-secondary-transfer transport guide 14 improves transport accuracy at the time when a sheet S is transported to the secondary transfer portion.

A high-voltage applying unit 10 applies, to the outside roller 9 for secondary transfer, a constant-voltage-controlled transfer bias of the polarity opposite to that of the toner images. Thus, the toner images on the intermediate transfer belt 6 are transferred onto the sheet S (secondary transfer). In the first embodiment, since the toner has negative polarity, a positive voltage is applied to the outside roller 9 for secondary transfer. In contrast, the stretch roller 21, which is an inside roller for secondary transfer, is electrically grounded. However, the high-voltage applying unit 10 may apply, to the stretch roller 21 which is an inside roller for secondary transfer, a constant-voltage-controlled transfer bias of the same polarity as that of the toner, and the outside roller 9 for secondary transfer may be electrically grounded.

A pre-fixing transport device 31 has a rotating belt on which the sheet S, on which the toner images have been transferred, is transported. A fixing device 30 heats and presses the sheet S to fix the toner images on the sheet S. A belt cleaning device 12 electrostatically collects secondary-transfer residual toner, which has not been transferred onto the sheet S and remains on the intermediate transfer belt 6, for cleaning. The cleaned intermediate transfer belt 6 is repeatedly used for image formation.

A main-body display unit 66 is disposed on an exterior of the image forming system 300. The main-body display unit 66 may be fixed directly on the exterior, or may be connected to the apparatus with a cable and may be disposed on the apparatus. Alternatively, the main-body display unit 66 may be connected to the apparatus body, not with a cable, through wireless communication using Bluetooth®.

### Schematic Configuration of Charge Removal Apparatus

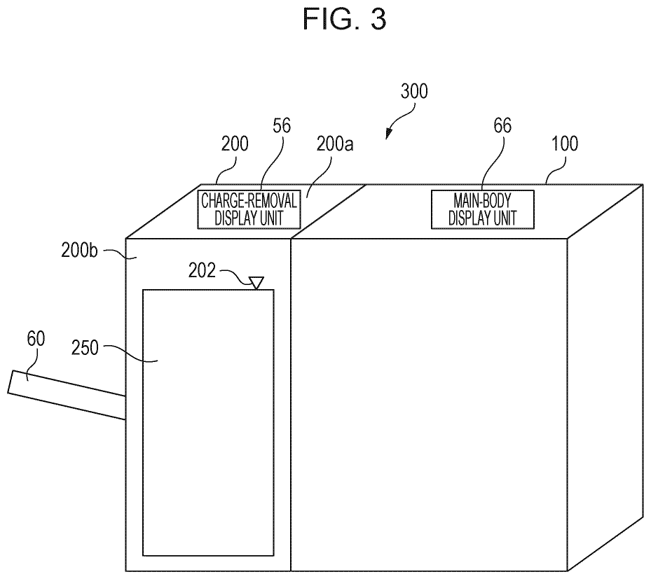

FIG. 2 illustrates the schematic configuration of the charge removal apparatus 200. FIG. 3 illustrates the image forming system 300. The charge removal apparatus 200 is disposed downstream of the image forming apparatus 100 in the sheet transport direction. In the secondary transfer described above, a high voltage of positive polarity is applied to the outside roller 9 for secondary transfer (see FIG. 1). Therefore, a sheet S, which has passed through the secondary transfer portion, has a positively-charged lower surface, and has a negatively-charged upper surface due to dielectric polarization. Thus, if sheets are stacked on an ejection tray 60 without being subjected to charge removal, the contact surfaces of the stacked sheets have opposite polarities, which may result in the sheets sticking to each other due to electrostatic force. To prevent sheets from being stuck due to electrostatic force, the charge removal apparatus 200 according to the first embodiment removes charges on sheet surfaces (upper surfaces and lower surfaces) by using a contact charge-removal unit 57 and a noncontact charge-removal unit 58.

The charge removal apparatus 200 may be directly connected to the image forming apparatus 100, or may be connected to the image forming apparatus 100 with a sheet processing apparatus such as an inserter interposed therebetween. The image forming apparatus 100 and the charge removal apparatus 200 may be formed as a single unit to constitute the image forming apparatus 100. The image forming apparatus 100 and the charge removal apparatus 200 may be formed as a single unit to constitute the charge removal apparatus 200. In other words, the image forming apparatus 100 and the charge removal apparatus 200 may be contained in a single housing or multiple housings.

The charge removal apparatus 200 includes a housing 59, the contact charge-removal unit 57, the noncontact charge-removal unit 58, a transport guide 53, and a controller (not illustrated) which controls the entire charge removal apparatus 200. The charge removal apparatus 200 further includes a charge-removal operation unit 54 and a charge-removal display unit 56. Charges on a sheet S, which has been transported from the image forming apparatus 100, are roughly removed by the contact charge-removal unit 57 which removes charges on a sheet in a contact state. Then, residual charges on the sheet S, which have failed to be removed by the contact charge-removal unit 57, are removed by the noncontact charge-removal unit 58 which removes charges on a sheet in a noncontact state, and the sheet is ejected to the outside of the charge removal apparatus 200. The details of the contact charge-removal unit 57, the noncontact charge-removal unit 58, and the charge-removal operation unit 54 will be described later.

As illustrated in FIG. 3, the charge-removal display unit 56, which has a light-emitting diode (LED), is disposed on a top surface 200a (the apparatus upper surface) of the exterior of the housing 59. The housing 59 houses the contact charge-removal unit 57, the noncontact charge-removal unit 58, and the transport guide 53. The charge-removal display unit 56 is disposed on an outer surface of the housing 59. Alternatively, the charge-removal display unit 56 may be disposed on a front surface 200b (the apparatus front surface) of the exterior of the charge removal apparatus 200. The surface facing the apparatus front surface side of the charge removal apparatus 200 is the front surface 200b including a sloping surface which inclines to cross the vertical direction. The charge-removal display unit 56, which is disposed on the top surface 200a or the front surface 200b of the exterior of the charge removal apparatus 200, enables a user to check the display content when the charge removal apparatus 200 is used. In other words, as long as the charge-removal display unit 56 is disposed on the outside of the exterior, any configuration may be employed. For example, the charge-removal display unit 56 may be directly fixed to the exterior, or may be connected to the apparatus with a cable and be disposed on the apparatus. The charge-removal display unit 56 may be connected to the apparatus body, not with a cable, through wireless communication using Bluetooth. The light of the charge-removal display unit 56 turns on and off in accordance with the state of ionizers 52 of the noncontact charge-removal unit 58.

In the first embodiment, the charge-removal display unit 56 has an LED. The configuration is not limited to this, and the charge-removal display unit 56 may be a display such as a liquid crystal display. The charge-removal display unit 56 may display not only information about the noncontact charge-removal unit 58, but also information about the contact charge-removal unit 57.

The charge removal apparatus 200 is provided with a cover 250 (FIG. 3) forming the apparatus front surface. The cover 250 is configured to be openable/closable on the housing 59 by using an opening/closing mechanism (not illustrated). Opening/closing the cover 250 of the charge removal apparatus 200 is detected by a cover sensor 202. A user opening the cover 250 enables an upper unit 401 and a lower unit 402 to be accessed. As illustrated in FIG. 2, specifically, a charge-removal opposing roller 51 and an ionizer 52a are disposed in the upper unit 401. A charge removal roller 50, an ionizer 52b, and the transport guide 53 are disposed in the lower unit 402. The upper unit 401 is openable/closable with respect to the lower unit 402.

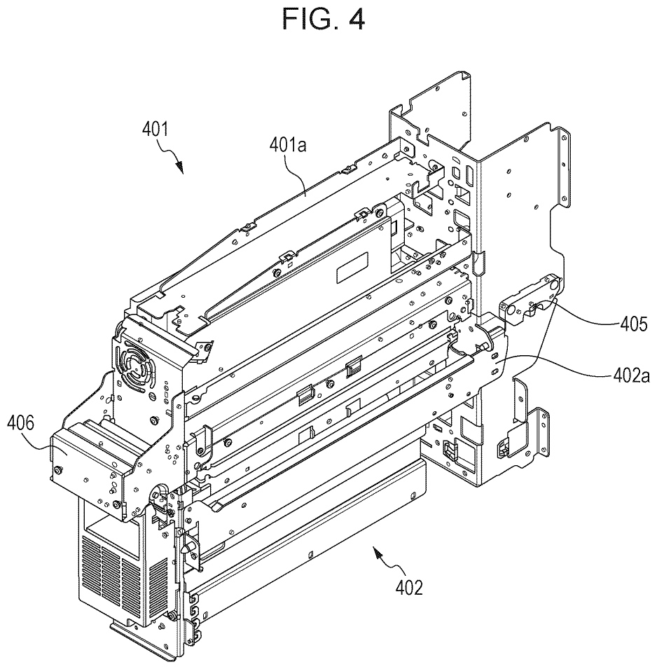

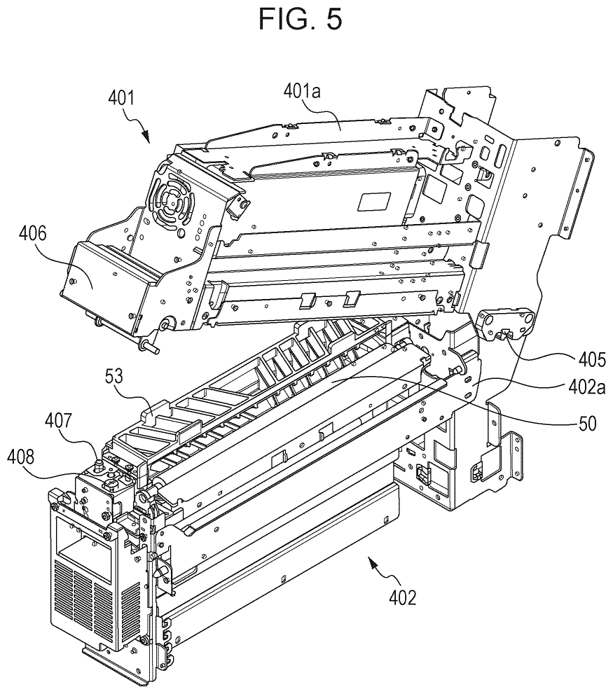

FIG. 4 is a perspective view of the upper unit 401 and the lower unit 402 in a state in which the upper unit 401 is closed. FIG. 5 is a perspective view of the upper unit 401 and the lower unit 402 in a state in which the upper unit 401 is opened. The upper unit 401 has an upper housing 401a formed of sheet metal or the like, and the ionizer 52a is fixed to the upper housing 401a. The lower unit 402 has a lower housing 402a formed of sheet metal, and the ionizer 52b is fixed to the lower housing 402a. The lower unit 402 is fixed so as not to move with respect to the housing 59 of the charge removal apparatus 200. In contrast, the upper unit 401 is provided so as to be pivotable about a rotating shaft 405 with respect to the lower unit 402. The upper unit 401 is provided with a handle 406. Since the upper unit 401 pivots in the inside of the housing 59, the pivotable range of the upper unit 401 is limited by the height of the top surface of the housing 59. That is, the upper unit 401 is pivotable in the range between the state in which the upper unit 401 is closed and the state in which the upper unit 401 is in contact with the top surface of the housing 59.

To maintain the charge removal performance of the ionizers 52, a user needs to maintain the electrode portions of the ionizers 52. The upper unit 401, which is formed so as to be pivotable with respect to the lower unit 402, allows a user to access the electrode portions.

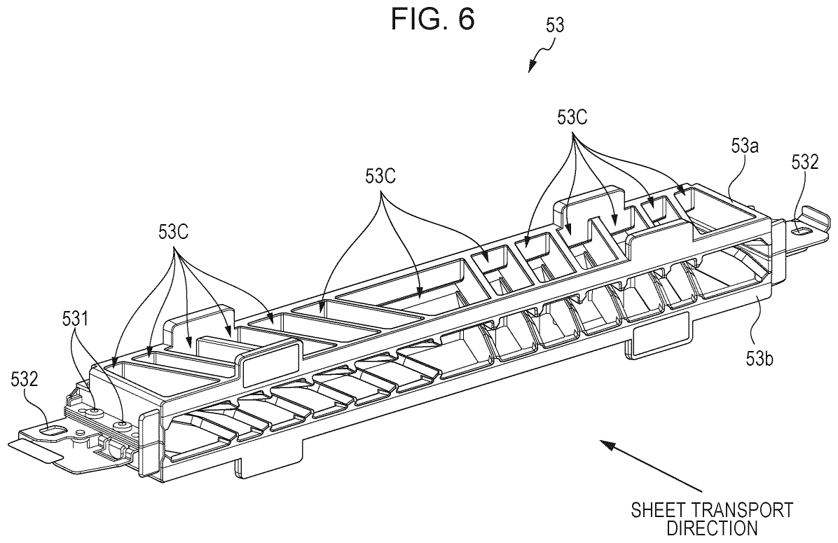

FIG. 6 is a perspective view of the transport guide 53 which guides a sheet. The transport guide 53 includes two fitting holes 532 into which protrusion portions 407 described later are fitted and which are provided in the width direction orthogonal to the sheet transport direction and on the outside of the transport path. In contrast, as illustrated in FIG. 5, the lower unit 402 includes the two protrusion portions 407 which protrude upward and which are provided in the width direction orthogonal to the sheet transport direction and on the outside of the transport path. The protrusion portions 407 of the lower unit 402 are fitted into the two respective fitting holes 532 of the transport guide 53. Thus, the transport guide 53 is positioned on the lower unit 402. The positioned transport guide 53 is attached so as to be removable from the lower housing 402a of the lower unit 402 with use of a screw 408 serving as a fixing member disposed on the apparatus front side. Alternatively, the transport guide 53 may be configured so as to be pivotable with respect to the lower unit 402, and may be fixed to the lower unit 402 by using an engaging member, rather than a screw.

In the configuration described above, when charge removal needles 520 of the ionizer 52a are to be cleaned, a user first opens the cover 250, and holds the handle 406 to make the upper unit 401 pivot upward. Thus, the user is allowed to access the charge removal needles 520 of the ionizer 52a. When charge removal needles of the ionizer 52b are to be cleaned, after making the upper unit 401 pivot upward, the user removes the transport guide 53 from the lower unit 402. Thus, the user is allowed to access the charge removal needles 520 of the ionizer 52b and to maintain (clean) the ionizers 52 of the noncontact charge-removal unit 58.

When a user makes the upper unit 401 pivot upward, the charge removal roller 50 is separated from the charge-removal opposing roller 51. Therefore, when a sheet jams in the charge removal apparatus, a user may make the upper unit 401 pivot to remove the jamming sheet.

### Contact Charge-Removal Unit

As illustrated in FIG. 2, the contact charge-removal unit 57 includes the charge removal roller 50 and the charge-removal opposing roller 51, which serve as a contact charge remover, and a high-voltage substrate 55, which generates a high voltage applied to the charge removal roller 50. The charge removal roller 50 is formed of core metal and an elastic layer of ionically conductive foam rubber. The charge removal roller 50 has an outside diameter of 20 to 25 mm. In measurement at 23° C. and 50% relative humidity (RH) with application of a voltage of 2 kV, the resistance value of the charge removal roller 50 is 1×10⁵ to 1×10⁸ Ω. The charge removal roller 50 is similar to the outside roller 9 for secondary transfer. A charge removal voltage, which is a constant-voltage-controlled direct current (DC) voltage, is applied to the charge removal roller 50 by the high-voltage substrate 55. In the first embodiment, as described above, a sheet S is transported to the charge removal apparatus 200 in a state in which the upper surface of the sheet is negatively charged and the lower surface of the sheet is positively charged. Therefore, the high-voltage substrate 55 applies a negative voltage to the charge removal roller 50 disposed on the lower surface side of a sheet.

The charge-removal opposing roller 51, which is formed of stainless steel (SUS), is electrically grounded (connected to the ground). The charge-removal opposing roller 51, having an outside diameter of 20 to 25 mm, is disposed at an opposite position of the charge removal roller 50.

The charge removal roller 50 and the charge-removal opposing roller 51 form a charge removal nip portion. The charge removal roller pair of the charge removal roller 50 and the charge-removal opposing roller 51 roughly remove charges on a sheet S in a contact state. The contact charge-removal unit 57 according to the first embodiment is in contact with a sheet S, and directly applies a voltage, achieving a high charge-removal effect. In contrast, the contact charge-removal unit 57 has such a characteristic that the variations of the surface potential of a sheet S after charge removal are likely to be large, indicating nonuniform charge removal. Accordingly, the charge removal apparatus 200 according to the first embodiment includes the noncontact charge-removal unit 58 disposed downstream of the contact charge-removal unit 57 in the sheet transport direction.

In the first embodiment, the charge-removal opposing roller 51 is driven by a charge-removal drive motor (not illustrated) to rotate, and transports a sheet S pinched by the charge removal nip. In the first embodiment, a negative voltage is applied to the charge removal roller 50 by the high-voltage substrate 55, and the charge-removal opposing roller 51 is electrically grounded. However, the configuration is not limited to this. A positive voltage may be applied to the charge-removal opposing roller 51 by the high-voltage substrate 55, and the charge removal roller 50 may be electrically grounded.

### Noncontact Charge-Removal Unit

The noncontact charge-removal unit 58 includes the ionizers 52 (52a, 52b) which serve as a noncontact charge remover. The ionizer 52a according to the first embodiment employs a bar-type ionizer which extends in the width direction orthogonal to the sheet transport direction, and includes charge removal needles 520, which generate ions, and an ionizer controller 521, which controls the ionizer. The ionizer 52b has a configuration similar to that of the ionizer 52a. The ionizers 52 are disposed vertically with the transport guide 53 interposed therebetween. The ionizer 52a is disposed above the transport guide 53; the ionizer 52b is disposed below the transport guide 53. Alternating current (AC) biases are applied to the ionizers 52, and positive ions and negative ions are emitted alternately through corona discharge. Therefore, regardless of the polarity directions of the residual charges on a sheet S after charge removal of the contact charge-removal unit 57, the residual charges on the front and back surfaces of a sheet may be removed at the same time. The effect of charge removal of a sheet S, which is obtained by the noncontact charge-removal unit 58 according to the first embodiment, is smaller than that by the contact charge-removal unit 57. However, the variations of the surface potential of a sheet S after the charge removal are small. Therefore, the noncontact charge-removal unit 58 may make the surface potential of a sheet S, which has become nonuniform due to the contact charge-removal unit 57, uniform. The charge removal needles 520 according to the first embodiment are examples of an electrode portion.

The transport guide 53, which is a member for guiding a sheet, includes an upper transport guide 53a, which is disposed opposite the upper surface of a sheet, and a lower transport guide 53b, which is disposed opposite the lower surface of the sheet. The transport guide 53 is disposed vertically below the ionizer 52a, which is disposed in the upper unit 401, and vertically above the ionizer 52b, which is disposed in the lower unit 402. That is, the transport guide 53 is disposed vertically between the ionizer 52a and the ionizer 52b. A sheet, which has passed through the charge removal roller pair of the charge removal roller 50 and the charge-removal opposing roller 51, is transported between the upper transport guide 53a and the lower transport guide 53b. The upper transport guide 53a and the lower transport guide 53b use an insulating resin which is a composite of polycarbonate (PC) and acrylonitrile-butadiene-styrene (ABS). The volume resistivity of the transport guide according to the first embodiment is 1×10¹⁴ Ω·cm.

FIG. 6 is a perspective view of the transport guide 53. The transport guide 53a is provided with openings 53c so as not to cause the transport guide 53 to physically block ions generated by the charge removal needles 520 which are ion emitting units. Specifically, the upper transport guide 53a has the openings 53c arranged in the width direction orthogonal to the sheet transport direction. Similarly, the lower transport guide 53b has multiple openings. The upper transport guide 53a and the lower transport guide 53b are fixed to each other by using multiple screws 531 disposed on both end portions in the width direction, and form a single guide unit (transport guide 53).

In the first embodiment, the ionizers 52 are employed as the noncontact charge-removal unit. However, the configuration is not limited to this. For example, the noncontact charge-removal unit may be an AC corotron system which applies a high voltage to a wire. In the first embodiment, the ionizers 52 are disposed on the upper surface side and the lower surface side of a sheet. However, the configuration is not limited to this. For example, an ionizer 52 may be disposed only on the upper side or the lower side of a sheet. The high voltage that is to be applied may be a DC voltage, not an AC voltage.

### Configuration of Charge-removal Operation Unit

In the first embodiment, the two charge-removal units of the contact charge-removal unit 57 and the noncontact charge-removal unit 58 are provided to remove charges on a sheet. However, the charge removal apparatus 200 may operate only the noncontact charge-removal unit 58 to remove charges on a sheet without operating the contact charge-removal unit 57. For example, for a sheet such as plain paper having a small electrical resistance, without use of the contact charge-removal unit 57, only the noncontact charge-removal unit 58 may be used to remove charges on such a sheet, achieving sufficient charge removal of the sheet.

In contrast, for a sheet such as synthetic paper having a large electrical resistance, it is preferable to use both the contact charge-removal unit 57 and the noncontact charge-removal unit 58 to remove charges on a sheet. Therefore, a user may appropriately change the settings of the charge removal apparatus 200 by using the charge-removal operation unit 54 in accordance with the type of a sheet to be printed in a job.

The charge-removal operation unit 54 is disposed on the top surface 200a (apparatus upper surface) of the housing of the charge removal apparatus 200. Alternatively, the charge-removal operation unit 54 may be disposed on the front surface 200b (apparatus front surface) of the housing of the charge removal apparatus 200. In the first embodiment, the charge-removal operation unit 54 includes a mode lever 54a and a dial 54b. The mode lever 54a is a selector switch for manually switching between “ON” and “OFF” (enable and disable) of the application of a voltage to the charge removal roller 50 by the high-voltage substrate 55. Even when the mode lever 54a is OFF, a sheet is transported. Even when the setting of the mode lever 54a is set to OFF, the noncontact charge-removal unit 58 performs charge removal.

The dial 54b is a thumb rotary switch for manually setting the value of a voltage that is to be applied to the charge removal roller 50 by the high-voltage substrate 55. In the first embodiment, the charge-removal operation unit includes the two manual setting units of the mode lever 54a and the dial 54b. Thus, a user may change the setting of the mode lever without changing the setting of the dial 54b.

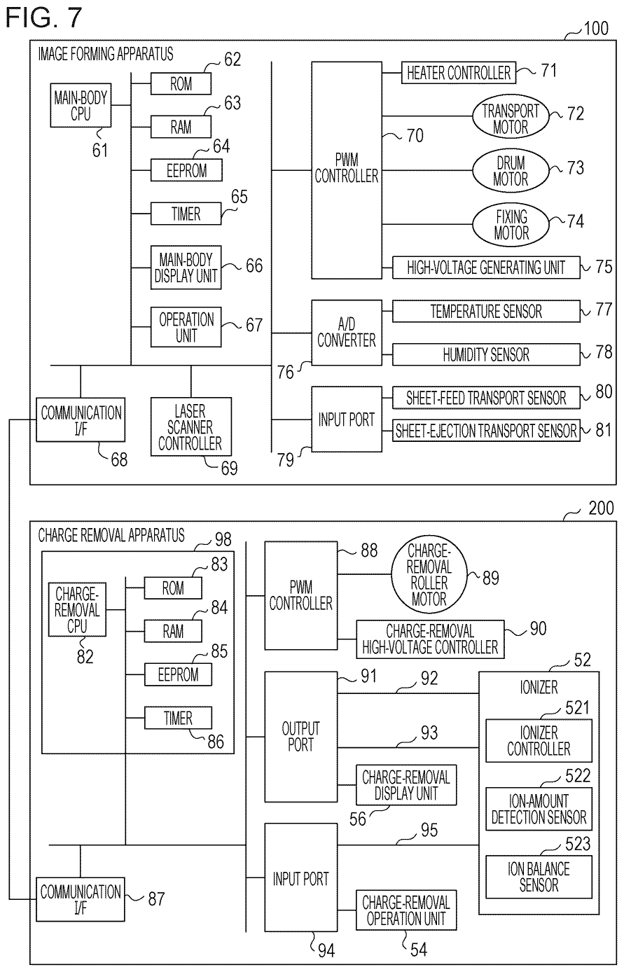

However, setting of the value of a voltage that is to be applied to the charge removal roller 50 is not limited to a user's manual setting. The image forming apparatus 100 may transmit a sheet type to the charge removal apparatus 200, and, on the basis of the sheet type, a charge-removal CPU 82 (FIG. 7) of the charge removal apparatus 200 may determine the value of a voltage that is to be applied to the charge removal roller 50. Alternatively, detection rollers or surface potential sensors which detect the amounts of charges on a sheet may be disposed in the charge removal apparatus 200. The detection rollers or the surface potential sensors may be used to measure the amounts of charges on a sheet after image formation. In accordance with the measured amounts of charges on a sheet, the charge-removal CPU 82 may determine the value of a voltage that is to be applied to the charge removal roller 50. Alternatively, the method of setting the value of a voltage that is to be applied to the charge removal roller 50 may be selected from a user's manual setting and automatic setting through measurement of the amounts of charges on a sheet using detection rollers or the like.

### Block Diagram of Image Forming System

FIG. 7 is a block diagram illustrating the electrical configuration of the image forming apparatus 100 and the charge removal apparatus 200. The configuration of the image forming apparatus 100 will be described first. The image forming apparatus 100 includes the main-body CPU 61, a read-only memory (ROM) 62, a random-access memory (RAM) 63, an electrically erasable programmable ROM (EEPROM) 64, a timer 65, the main-body display unit 66, an operation unit 67, a communication I/F 68, a laser scanner controller 69, a pulse width modulation (PWM) controller 70, an analog/digital (A/D) converter 76, and an input port 79. These components are connected through a system bus. A heater controller 71, a transport motor 72, a drum motor 73, a fixing motor 74, and a high-voltage generating unit 75 are connected to the PWM controller 70. A temperature sensor 77 and a humidity sensor 78 are connected to the A/D converter 76. A sheet-feed transport sensor 80 and a sheet-ejection transport sensor 81 are connected to the input port 79.

The main-body CPU 61 comprehensively performs image processing control and print control on the basis of stored programs and the like.

The ROM 62 and the EEPROM 64 store programs and data which are necessary when the main-body CPU 61 executes various processes. The RAM 63 works as a work area. The timer 65 is used when the main-body CPU 61 executes various timing control. The main-body display unit 66 displays, for example, setting information of the image forming apparatus 100 and the processing state of a print job. The operation unit 67 receives input of various settings and operation instructions from a user. The communication I/F 68, which is connected to the charge removal apparatus 200 through a communication cable, performs communication for control of the apparatuses.

The laser scanner controller 69 is a device that emits, for formation of electrostatic latent images, laser light, which has been modulated in accordance with image data, to the photoconductive drums 1 electrostatically charged. The laser scanner controller 69 emits laser light to the photoconductive drums 1 which are electrostatically charged at a uniform negative potential by the high-voltage generating unit 75 described later, while deflecting the laser light with a polygonal mirror. Thus, negative charges on the portions of the photoconductive drums 1 irradiated with laser light are neutralized to form electrostatic latent images.

The PWM controller 70 controls the heater controller 71, the transport motor 72, the drum motor 73, the fixing motor 74, and the high-voltage generating unit 75. The heater controller 71 performs temperature control on the fixing device 30. The transport motor 72 drives transport rollers for transporting a sheet, and the pre-fixing transport device 31. The drum motor 73 drives rotation of the photoconductive drums 1. The fixing motor 74 drives fixing belts and the like of the fixing device 30. The A/D converter 76 performs A/D conversion for converting an analog signal, which is outputted from the temperature sensor 77 and the humidity sensor 78, to a digital signal. The input port 79 receives output signals from the sheet-feed transport sensor 80 and the sheet-ejection transport sensor 81.

The configuration of the charge removal apparatus 200 will be described. The charge removal apparatus 200 includes the charge-removal CPU 82, a ROM 83, a RAM 84, an EEPROM 85, a timer 86, a communication I/F 87, a PWM controller 88, an output port 91, and an input port 94. In the first embodiment, a charge-removal controller 98 includes the charge-removal CPU 82, the ROM 83, the RAM 84, the EEPROM 85, and the timer 86. These components are connected to one another through a system bus. A charge-removal roller motor 89 and a charge-removal high-voltage controller 90 are connected to the PWM controller 88. An ionizer ON/OFF signal 92 and a maintenance-detection-mode shift signal 93 are outputted from the output port 91. The charge-removal display unit 56 is connected to the output port 91 from which data in accordance with information to be displayed on the charge-removal display unit 56 is outputted. To the input port 94, a maintenance detection signal 95 is inputted, and the charge-removal operation unit 54 is connected. The ionizers 52 receive the ionizer ON/OFF signal 92 and the maintenance-detection-mode shift signal 93, and output the maintenance detection signal 95.

The charge-removal CPU 82 performs various types of control, which are necessary for charge removal and ejection of a sheet, on the basis of stored programs and the like. The ROM 83 and the EEPROM 85 store programs and data which are necessary when the charge-removal CPU 82 performs various processes. The RAM 84 works as a work area. The timer 86 is used for various timing control by the charge-removal CPU 82 and measures the operating time of the ionizers 52. The communication I/F 87, which is connected to the image forming apparatus 100 through a communication cable, performs communication for control of the apparatuses.

The PWM controller 88, which controls the charge-removal roller motor 89 and the charge-removal high-voltage controller 90, removes charges on a sheet ejected from the image forming apparatus 100, and transports the sheet. The output port 91 outputs the ionizer ON/OFF signal 92, the maintenance-detection-mode shift signal 93, and the ON/OFF state of the charge-removal display unit 56. The input port 94 receives the maintenance detection signal 95 and the ON/OFF state of the charge-removal operation unit 54.

The ionizers 52 switch between generating and stopping ions in accordance with the ionizer ON/OFF signal 92. When the ionizer ON/OFF signal 92 is at the H level, ions are generated; when the ionizer ON/OFF signal 92 is at the L level, generation of ions is stopped. The charge-removal CPU 82 switches the ionizer ON/OFF signal 92 at predetermined times to control generating and stopping ions.

The maintenance-detection-mode shift signal 93 is a signal for shifting the ionizers to the maintenance detection mode in which whether maintenance of the electrode portions is necessary is determined. The charge-removal CPU 82 switches the maintenance-detection-mode shift signal 93 from the L level to the H level at predetermined times. Thus, the ionizers 52 are shifted to the maintenance detection mode. The maintenance-detection-mode shift signal 93 is switched from the H level to the L level 100 milliseconds (ms) after being switched from the L level to the H level.

The maintenance detection signal 95 is a signal outputted when, in the maintenance detection mode of the ionizers, it is determined that maintenance of the electrode portions is necessary. Specifically, the maintenance-detection-mode shift signal 93 switching from the L level to the H level triggers the ionizer controller 521 shifting to the maintenance detection mode in which whether maintenance is necessary is determined. The ionizer controller 521 determines whether maintenance is necessary in the maintenance detection mode. The result of determination by the ionizer controller 521 as to whether maintenance is necessary is reflected to the maintenance detection signal 95. Specifically, the case in which a predetermined time has elapsed in a state in which the maintenance detection signal 95 is at the L level indicates that maintenance is not necessary; the case of the H level indicates that maintenance is necessary. In the maintenance detection mode, the ionizer controller 521 continues a maintenance detection operation until the maintenance detection signal 95 at the H level is outputted or the predetermined time has elapsed.

When the maintenance detection signal 95 at the H level is outputted from the ionizer controller 521, the charge-removal CPU 82 instructs the main-body display unit 66, through the communication I/F 87, to display a maintenance alert for recommending execution of maintenance of the ionizers 52. In the description below, the state in which the maintenance detection signal 95 is at the H level corresponds to the state in which the maintenance detection signal 95 is outputted.

Each ionizer 52 includes the ionizer controller 521, an ion-amount detection sensor 522, which detects the amount of ions, and an ion balance sensor 523, which detects the balance between positive ions and negative ions. In the maintenance detection mode, the ionizer controller 521 uses the ion-amount detection sensor 522 and the ion balance sensor 523 to determine whether the ionizer is capable of outputting a normal amount of ions or performing output with a normal ion balance.

### Maintenance Detection Control of Ionizer

When the ionizers 52 detect the maintenance-detection-mode shift signal, the ionizers 52 perform a maintenance-necessity detection operation. Specifically, when each ionizer 52 detects the maintenance-detection-mode shift signal 93, the ionizer 52 starts operating, and the ion-amount detection sensor 522 detects the amount of generated ions per unit time. A voltage of a predetermined value is applied to the charge removal needles 520. When the detected amount of generated ions is less than a predetermined amount, the ionizer controller 521 outputs the maintenance detection signal 95.

When the detected amount of generated ions is greater than or equal to the predetermined amount, a positive voltage or a negative voltage, which is applied to the charge removal needles 520, is gradually increased so that the ion balance detected by the ion balance sensor 523 is within a predetermined range. In the first embodiment, a positive voltage (a positive-polarity high-voltage pulse) and a negative voltage (a negative-polarity high-voltage pulse) are alternately and repeatedly applied to the charge removal needles 520. That is, the amplitude of a positive voltage or the amplitude of a negative voltage is increased, so that feedback control for adjusting the ion balance between positive ions and negative ions is performed. In other words, a positive voltage or a negative voltage is controlled so that the ion balance detected by the ion balance sensor 523 comes close to zero. An ion balance which is within the predetermined range refers to the state in which the difference between the amount of generated positive ions and that of generated negative ions, which are generated from the ionizer 52 in one of the upper unit 401 and the lower unit 402, is within the predetermined range.

Even when the ionizer 52 increases, to the predetermined upper limit, a voltage applied to the charge removal needles 520, if the ion balance is not within the predetermined range, the ionizer controller 521 outputs the maintenance detection signal 95. In contrast, even if the ion balance is within the predetermined range, the ionizer controller 521 continues maintenance detection control for 30 seconds from detection of the maintenance-detection-mode shift signal 93. The maintenance detection control ends 30 seconds after detection of the maintenance-detection-mode shift signal 93.

That is, in the case where the amount of ions generated by the ionizer 52 is less than a predetermined amount of ions, and the case where the ion balance is not within the predetermined range, the ionizer controller 521 outputs the maintenance detection signal 95. In the first embodiment, the ion-amount detection sensor 522 and the ion balance sensor 523 are provided. However, the configuration is not limited to this. The amount of generated ions or the ion balance may be calculated on the basis of a positive/negative ion current (return current) which returns to the ionizer circuit through the ground.

In the first embodiment, the detection process of the ionizers detects whether maintenance of the ionizers is necessary. However, the configuration is not limited to this. The detection process of the ionizers may detect contamination of the ionizers, or may measure the performance of the ionizers.

### Screen Display of User Operation Unit

In an apparatus of the related art, a user's careless operation may interrupt a maintenance-necessity detection operation of detecting whether maintenance is necessary.

Specifically, a user may turn off the power supply of an apparatus body or submit a new job during a maintenance-necessity detection operation. This may cause interruption of the maintenance-necessity detection operation. The time to perform a maintenance-necessity detection operation depends on the job submission state, such as the length or frequency of a job. Thus, a user (operator) fails to grasp when a maintenance-necessity detection operation is being performed.

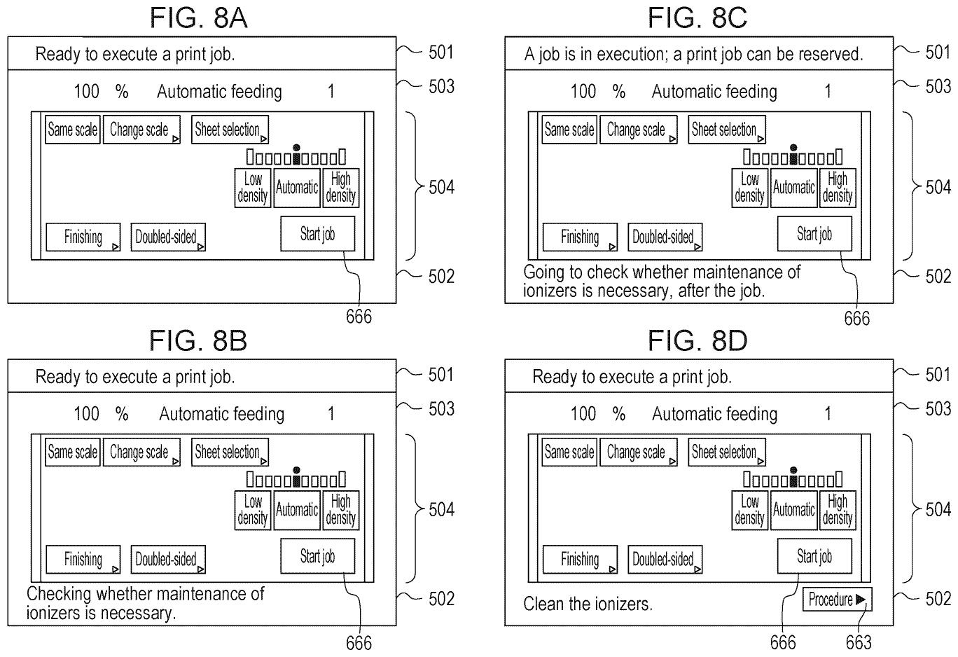

FIGS. 8A to 8D illustrate displays on the main-body display unit 66 of the image forming apparatus 100. The main-body display unit 66 displays the setting information of the image forming apparatus 100, the processing state of a print job, and the like. In the first embodiment, in addition to display of setting information and the processing state of a print job, the main-body display unit 66, which is a touch panel, receives, from a user, input of various settings and operation instructions.

The display screen includes a status area 501, which is disposed on the upper side of the display screen and which is used to display the state of the image forming apparatus, and an alert area 502, which is disposed on the lower side of the display screen and which is used to display an alert from the image forming apparatus 100 and the charge removal apparatus 200. Further, the display screen includes a job setting area 504, which is used for a user to set a job, between the status area 501 and the alert area 502. Between the status area 501 and the job setting area 504, the display screen further includes a setting display area 503 used to display settings, which are set by a user and which are used when a job is submitted to the image forming apparatus 100. In the status area 501, for example, a message that a print job is ready to be received for execution, a message that a print job is being performed, or a message that a print job is not ready to be received for execution for some reason is displayed.

FIG. 8A illustrates a display screen in the case where the image forming apparatus 100 is ready to perform a print job. FIG. 8B illustrates a display screen displayed during a maintenance-necessity detection operation. FIG. 8C illustrates a display screen for advance notice of a maintenance-necessity detection operation. FIG. 8D illustrates a display screen for notifying the result of a maintenance-necessity detection operation.

FIG. 8A illustrates a display screen on the main-body display unit 66 in the case where the maintenance detection signal 95 has not been outputted. FIG. 8D illustrates a display screen on the main-body display unit 66 in the case where the maintenance detection signal 95 has been outputted. FIG. 8B illustrates a display screen on the main-body display unit 66 in the case where a maintenance-necessity detection operation is being performed. FIG. 8C illustrates a display screen on the main-body display unit 66 displayed when the condition of start of a maintenance-necessity detection operation is satisfied, until start of a maintenance-necessity detection operation.

In the first embodiment, even when a maintenance-necessity detection operation is being performed, the main-body CPU 61 is ready to receive a job. Therefore, in the screen in FIG. 8B, a message for notifying that whether maintenance of the ionizers is necessary is being checked is displayed in the alert area 502. In addition, a message that a job is ready to be received is displayed in the status area 501.

Even before execution of a maintenance-necessity detection operation, the main-body CPU 61 is ready to receive a job. Therefore, in the screen in FIG. 8C, a message for notifying that whether maintenance of the ionizers is necessary is to be checked after a job is displayed in the alert area 502. In addition, a message that a job is ready to be received is displayed in the status area 501. When the displays in FIGS. 8B and 8C are displayed, a message that the power supplies of the image forming apparatus 100 and the charge removal apparatus 200 are not to be turned off or a message that a print job is not to be submitted may be also displayed.

As a result of a maintenance-necessity detection operation, even when an alert indicating that maintenance of the ionizers 52 is to be performed is notified, the main-body CPU 61 is ready to receive a job. Therefore, in the screen in FIG. 8D, a message for prompting cleaning of the ionizers is displayed in the alert area 502. In addition, a message that a job is ready to be received is displayed in the status area 501. Further, a guidance key 663 for displaying guidance about the cleaning procedure is displayed in the alert area 502. When a user presses the guidance key 663, guidance about the cleaning procedure is displayed in the display screen. Specifically, as the cleaning procedure, how a user accesses the electrode portions of the ionizers 52 and how to clean the electrode portions by using cleaning members may be described with illustrations, messages, movies, and the like. For example, how to access the electrode portions of the ionizers may be described by displaying a message that the upper unit 401 of the charge removal apparatus 200 is to be lifted upward.

In the first embodiment, a notification of prompting a user to clean the ionizers is displayed on the main-body display unit 66 of the image forming apparatus 100. However, the configuration is not limited to this. A notification of prompting a user to clean the ionizers may be displayed by using the charge-removal display unit 56 of the charge removal apparatus 200. For example, the notification may be displayed through the LED of the charge-removal display unit 56 with a change in the display color, the luminous intensity of the light, the blinking cycle, or the like. For example, a user may be notified with text or the like on the display of the charge-removal display unit 56. Alternatively, both the main-body display unit 66 and the charge-removal display unit 56 may be used.

Operation of Charge-Removal Controller according to First Embodiment

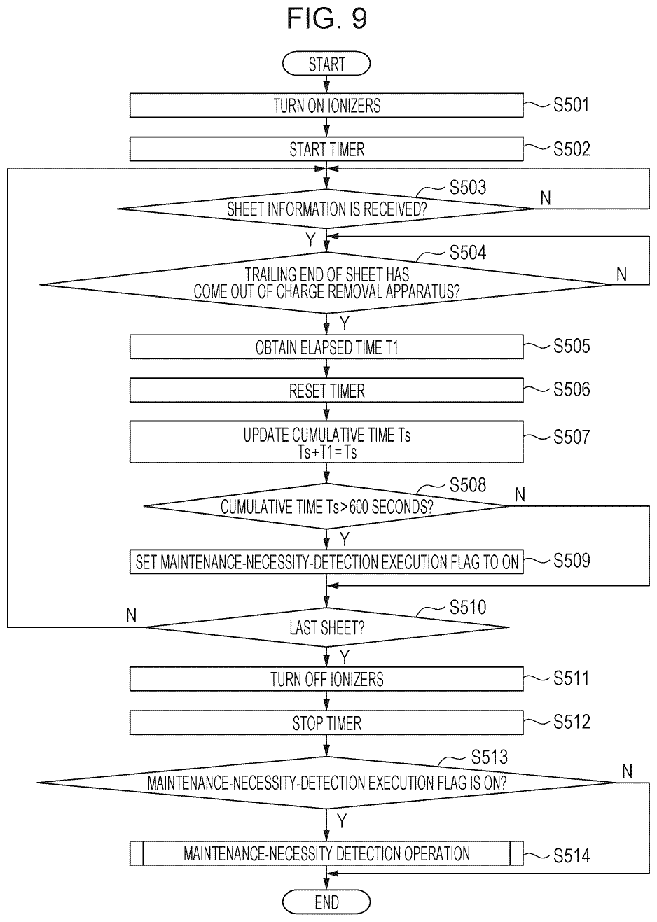

FIG. 9 is a flowchart of control performed by the charge-removal CPU 82 of the charge-removal controller 98 according to the first embodiment. Before start of a job, as illustrated in FIG. 8A, the main-body display unit 66 of the image forming apparatus 100 displays a message that a print job is ready to be received for execution. When a job starts, a process by the charge-removal CPU 82 starts through the communication I/F 87.

The charge-removal CPU 82 switches the ionizer ON/OFF signal 92 from the L level to the H level, and starts output of the ionizers 52 (S501). The charge-removal CPU 82 causes the timer 86 to start measurement of the operating time of the ionizers 52 (S502). The timer 86 starts time measurement from zero second. The charge-removal CPU 82 waits until sheet information of the job is received from the image forming apparatus 100 through the communication I/F 87 (S503-N). The sheet information of a job is data including information about whether the sheet is the last sheet of the job, and is transmitted at a time when a sheet is passed from the image forming apparatus 100 to the charge removal apparatus 200.

If the charge-removal CPU 82 receives the sheet information of the job from the image forming apparatus 100 through the communication I/F 87 (S503-Y), the charge-removal CPU 82 determines whether the trailing end of the sheet has come out of the charge removal apparatus 200 (S504). Specifically, the charge-removal CPU 82 determines whether the trailing end of a sheet has come out, on the basis of the time elapse from the time of reception of the sheet information. If the charge-removal CPU 82 determines that the trailing end of the sheet has come out of the charge removal apparatus 200 (S504-Y), the charge-removal CPU 82 obtains the elapsed time T1 of the timer 86 (S505), and resets the timer 86 (S506). The reset timer 86 starts measurement of time from zero second again. The accumulated time of the elapsed times T1 of the ionizers 52 after the previous maintenance-necessity detection operation is stored as a cumulative time Ts in a memory. The charge-removal CPU 82 adds the elapsed time T1, which has been measured by the timer 86, to the cumulative time Ts to update the cumulative time Ts (S507). The cumulative time Ts is stored in a nonvolatile memory.

The charge-removal CPU 82 determines whether the cumulative time Ts exceeds 600 seconds (S508). If the cumulative time Ts exceeds 600 seconds (S508-Y), the charge-removal CPU 82 sets a maintenance-necessity-detection execution flag in the RAM 84 to ON (S509). If the cumulative time Ts does not exceed 600 seconds (S508-N), the process proceeds to S510. The charge-removal CPU 82 determines whether the sheet, which is determined to have come out of the charge removal apparatus 200 in S504, is the last sheet (S510). If the sheet is not the last sheet (S510-N), the process returns to the process of receiving the sheet information (S503) again. If the sheet is the last sheet (S510-Y), the charge-removal CPU 82 switches the ionizer ON/OFF signal 92 from the H level to the L level to stop the output of the ionizers 52 (S511), and stops the timer 86 (S512).

The charge-removal CPU 82 determines whether the maintenance-necessity-detection execution flag stored in the RAM 84 is ON (S513). If the maintenance-necessity-detection execution flag is OFF (S513-N), the charge-removal CPU 82 ends the process. If the maintenance-necessity-detection execution flag is ON (S513-Y), the charge-removal CPU 82 performs a maintenance-necessity detection operation (S514), and ends the process. The charge-removal CPU 82 sets the maintenance-necessity-detection execution flag to OFF just before execution of the maintenance-necessity detection operation. The time when the maintenance-necessity-detection execution flag is set to OFF is not limited to this. For example, the maintenance-necessity-detection execution flag may be set to OFF at the time when the cumulative time Ts is cleared, which is described later.

However, the charge removal process in which the ionizers remove charges on multiple sheets transported from the image forming units may be performed by the ionizer controllers 521, or may be performed by the charge-removal controller 98.

In addition, the detection process of detecting whether maintenance of the ionizers is necessary may be performed by the ionizer controllers 521, or may be performed by the charge-removal controller 98. In the first embodiment, the charge-removal controller 98 and the ionizer controllers 521 are examples of a controller.

In the first embodiment, to determine whether a maintenance-necessity detection operation is to be performed, the cumulative time Ts of the ionizers is compared with a first threshold Tslimit. In the first embodiment, 600 seconds is an example of the first threshold Tslimit. The first threshold Tslimit may be set appropriately. In the first embodiment, the cumulative time Ts is an example of an accumulated operating time of the ionizers 52.

The way of determining whether a maintenance-necessity detection operation is to be performed is not limited to this. For example, in addition to the first threshold Tslimit compared with the cumulative time Ts which is an accumulated time from execution of the previous maintenance-necessity detection operation, a second threshold T2 limit compared with the operating time T2 of the ionizers 52 in a single job may be set.

In other words, when the cumulative time Ts obtained by accumulating the operating times T1 of the ionizers 52 in multiple charge removal processes exceeds the first threshold, a maintenance-necessity detection operation is performed. Further, even when the cumulative time Ts does not exceed the first threshold, if the operating time T2 of the ionizers 52 in a single charge removal process exceeds the second threshold, the charge-removal CPU 82 performs a maintenance-necessity detection operation. Thus, even when long-time jobs are repeatedly performed, a maintenance-necessity detection operation is performed at appropriate times. In addition, a maintenance-necessity detection operation may be performed when the power supply is turned OFF.

To determine whether a maintenance-necessity detection operation is to be performed, the operating time of the ionizers is used. However, the configuration is not limited to this. The determination may be performed by using the number of sheets which pass through the charge removal apparatus 200.

Maintenance-Necessity Detection Operation according to First Embodiment

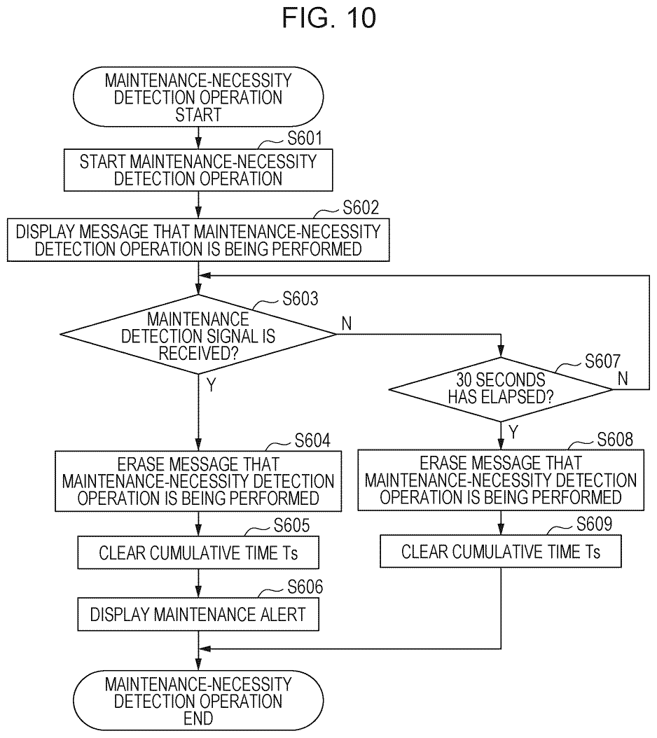

FIG. 10 is a flowchart of the maintenance-necessity detection operation according to the first embodiment. The flowchart in FIG. 10 describes the details of the maintenance-necessity detection operation in S514 in FIG. 9.

The charge-removal CPU 82 switches the maintenance-detection-mode shift signal 93 from the L level to the H level, and causes the ionizers 52 to start a maintenance-necessity detection operation (S601). The charge-removal CPU 82 instructs the main-body CPU 61 of the image forming apparatus 100, through the communication I/F 87, to display, on the main-body display unit 66, a message that a maintenance-necessity detection operation is being performed (S602). At that time, as illustrated in FIG. 8B, the main-body display unit 66 of the image forming apparatus 100 displays a message that an operation of detecting whether maintenance of the ionizers 52 is necessary is being performed.

If the charge-removal CPU 82 receives the maintenance detection signal 95 from the ionizers 52 (S603-Y), the charge-removal CPU 82 causes the main-body CPU 61, through the communication I/F 87, to erase the message, on the main-body display unit 66, that a maintenance-necessity detection operation is being performed. The charge-removal CPU 82 clears the cumulative time Ts (S605). The charge-removal CPU 82 notifies the main-body CPU 61 of an alert indicating that necessity of maintenance is detected (S606), and ends the process. When the main-body CPU 61 receives the maintenance alert notification from the charge-removal CPU 82, the main-body CPU 61 displays a maintenance alert for recommending cleaning of the ionizers (FIG. 8D).

If the charge-removal CPU 82 has not received the maintenance detection signal 95 from the ionizers 52 (S603-N), the charge-removal CPU 82 determines whether 30 seconds has elapsed after start of the maintenance-necessity detection operation (S607). If 30 seconds has not elapsed after start of the maintenance-necessity detection operation (S607-N), the process returns to S603. If 30 seconds has elapsed without reception of the maintenance detection signal 95 after start of the maintenance-necessity detection operation (S607-Y), the charge-removal CPU 82 erases, through the communication I/F 87, the message, on the main-body display unit 66, that a maintenance-necessity detection operation is being performed (S608). The charge-removal CPU 82 clears the cumulative time Ts (S609), and ends the process. In other words, the case in which a predetermined time has elapsed in a state in which the maintenance detection signal 95 remains at the L level indicates that a maintenance-necessity detection operation has been performed for the predetermined time. In this case, cleaning of the ionizers 52 is not necessary. Thus, the charge-removal CPU 82 does not display, on the main-body display unit 66, a maintenance alert for recommending cleaning of the ionizers, and displays the screen in FIG. 8A.

A maintenance-necessity detection operation may be performed during a charge removal process of removing, by the noncontact charge-removal unit, charges on a sheet in a noncontact state. In the first embodiment, output from the ionizers changes during a maintenance-necessity detection operation of the ionizers 52. Therefore, a charge removal process and a maintenance-necessity detection operation are not performed at the same time, and a maintenance-necessity detection operation is performed after a charge removal process.

Thus, a message that a maintenance-necessity detection operation is being performed is notified to the main-body display unit 66 or the charge-removal display unit 56 during the maintenance-necessity detection operation. This enables a user to grasp the operating state of the maintenance-necessity detection operation. Therefore, the possibility that a user unintentionally interrupts the maintenance-necessity detection operation may be reduced.

### Second Embodiment

In the first embodiment, a message that a maintenance-necessity detection operation is being performed is notified on the main-body display unit 66. In a second embodiment, in addition to a notification to the main-body display unit 66 that a maintenance-necessity detection operation is being performed, an advance notice of a maintenance-necessity detection operation is notified to the main-body display unit 66.

In the second embodiment, configurations and processes similar to those in the first embodiment will not be described, and only differences from the first embodiment will be described.

Operation of Charge-Removal Controller according to Second Embodiment

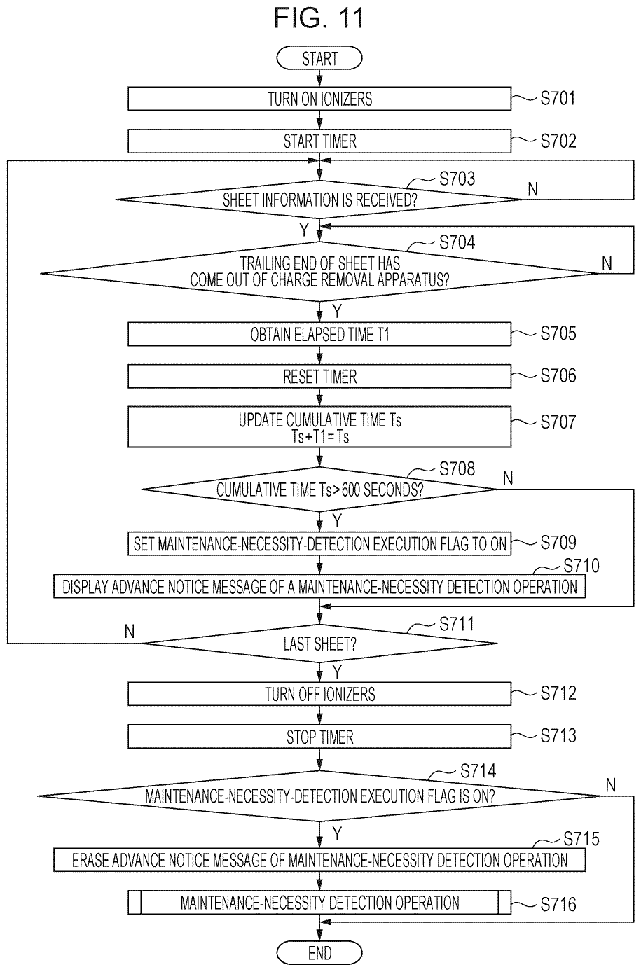

FIG. 11 is a flowchart of control performed by the charge-removal CPU 82 of the charge-removal controller 98 according to the second embodiment. The processes from S701 to S709 in FIG. 11 are similar to those from S501 to S509 in FIG. 9, and will not be described.

If the cumulative time Ts exceeds 600 seconds (S708-Y), the charge-removal CPU 82 sets the maintenance-necessity-detection execution flag in the RAM 84 to ON (S709). The charge-removal CPU 82 transmits, through the communication I/F 87, a notification to cause the main-body CPU 61 of the image forming apparatus 100 to display, on the main-body display unit 66, an advance notice message of a maintenance-necessity detection operation (S710). In this case, as illustrated in FIG. 8C, the main-body display unit 66 of the image forming apparatus 100 displays a message that an operation of detecting whether maintenance of the ionizers 52 is necessary is to be performed.

The charge-removal CPU 82 determines whether the sheet, which comes out from the charge removal apparatus 200 in S704, is the last sheet (S711). If the sheet is not the last sheet (S711-N), the process returns to S703. If the sheet is the last sheet (S711-Y), the charge-removal CPU 82 switches the ionizer ON/OFF signal 92 from the H level to the L level to stop the output of the ionizers 52 (S712), and stops the timer 86 (S713).

The charge-removal CPU 82 determines whether the maintenance-necessity-detection execution flag stored in the RAM 84 is ON (S714). If the maintenance-necessity-detection execution flag is OFF (S714-N), the charge-removal CPU 82 ends the process. If the maintenance-necessity-detection execution flag is ON (S714-Y), the charge-removal CPU 82 causes the main-body CPU 61, through the communication I/F 87, to erase the advance notice message of a maintenance-necessity detection operation, which is displayed on the main-body display unit 66 (S715). The charge-removal CPU 82 performs a maintenance-necessity detection operation (S716), and ends the process. The charge-removal CPU 82 sets the maintenance-necessity-detection execution flag to OFF just before execution of a maintenance-necessity detection operation.

A maintenance-necessity detection operation is similar to that in the first embodiment, and will not be described.

In the second embodiment, when the maintenance-necessity-detection execution flag is set to ON, the charge-removal CPU 82 causes the main-body display unit 66 to display an advance notice message of a maintenance-necessity detection operation. In other words, when it is determined, during a job, that a maintenance-necessity detection operation is to be performed, the main-body display unit 66 displays, during execution of the job, an advance notice message of a maintenance-necessity detection operation. However, the configuration is not limited to this. When the maintenance-necessity-detection execution flag is set to ON, the main-body display unit 66 may display an advance notice message of a maintenance-necessity detection operation at a predetermined time before end of the job. Alternatively, when the maintenance-necessity-detection execution flag is set to ON, the main-body display unit 66 may display an advance notice message of a maintenance-necessity detection operation at a predetermined number of pages before end of the job. That is, any configuration may be employed as long as the main-body display unit 66 displays an advance notice message of a maintenance-necessity detection operation, after the maintenance-necessity-detection execution flag is set to ON until the maintenance-necessity detection operation starts.

Thus, when the charge-removal CPU 82 determines that a maintenance-necessity detection operation is to be performed, the charge-removal CPU 82 causes the main-body display unit 66 to display an advance notice message of a maintenance-necessity detection operation. This enables a user to know in advance that a maintenance-necessity detection operation will be performed after a print job. Thus, the user may appropriately delay submission of the next print job.

### Third Embodiment

In a third embodiment, when a user submits a job while an advance notice of a maintenance-necessity detection operation is notified or a maintenance-necessity detection operation is being performed, the maintenance-necessity detection operation is interrupted, and the main-body display unit 66 displays a message for confirming to the user that the job is to be performed. In the third embodiment, configurations and processes similar to those in the first embodiment and the second embodiment will not be described, and only differences will be described.

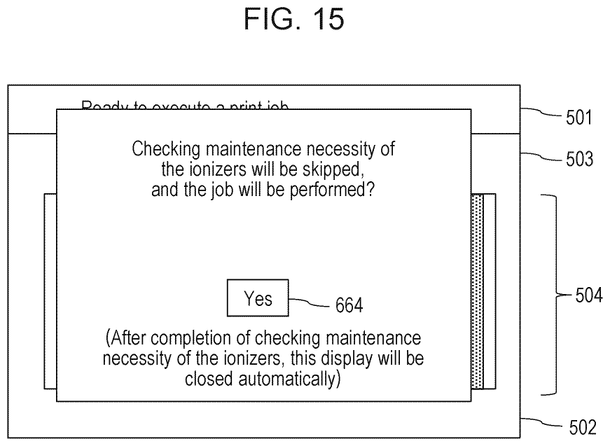

FIG. 15 is a screen on the main-body display unit 66 when a user submits a job while an advance notice of a maintenance-necessity detection operation is notified or a maintenance-necessity detection operation is being performed. A job confirmation message is displayed on the main-body display unit 66 so that at least a part of the message overlaps the job setting area 504. Specifically, the main-body display unit 66 displays a message for confirming whether a maintenance-necessity detection operation is to be skipped and the job is to be performed. The display unit 66 displays an accept button 664 for a user to select skipping the maintenance-necessity detection operation and performing the submitted job.

When a user presses the accept button 664, the execution confirmation message is erased, and the maintenance-necessity detection operation is skipped or interrupted. When the user does not press the accept button 664, the maintenance-necessity detection operation is performed or continued. When the accept button 664 is not pressed and the maintenance-necessity detection operation is completed, the main-body display unit 66 erases the execution confirmation message and the accept button 664 in FIG. 15.

In addition to the accept button 664, the main-body display unit 66 may display a reject button. “Yes” is displayed on the accept button 664; “No” is displayed on the reject button. When a user presses the reject button, the main-body CPU 61 does not wait until execution of the maintenance-necessity detection operation is completed, and causes the main-body display unit 66 to erase the message, the accept button 664, and the reject button which are illustrated in FIG. 15. The charge-removal CPU 82 causes the ionizers to perform or continue the maintenance-necessity detection operation.

Operation of Charge-Removal Controller according to Third Embodiment

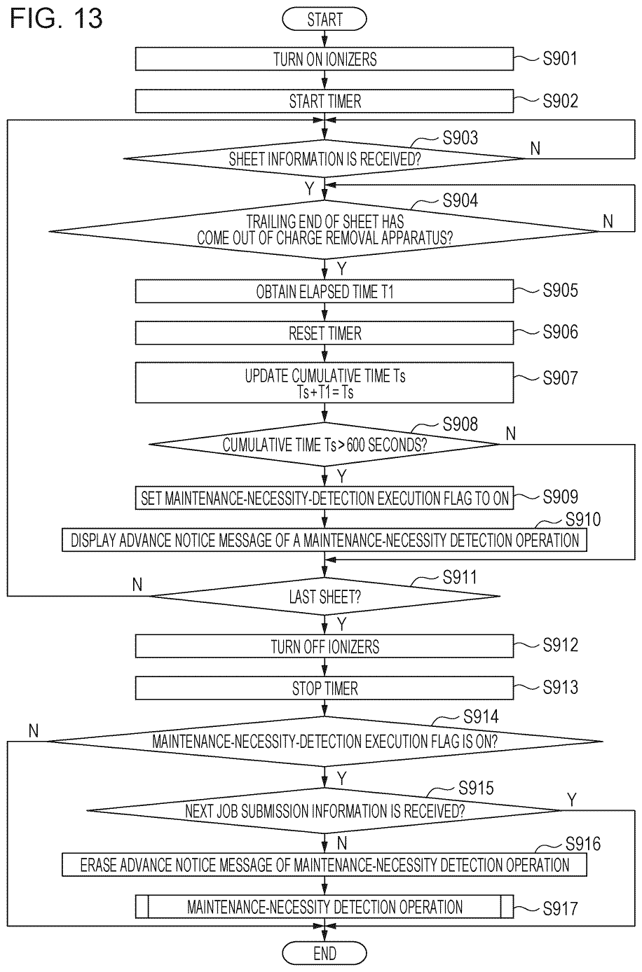

FIG. 13 is a flowchart of control performed by the charge-removal CPU 82 of the charge-removal controller 98 according to the third embodiment. The processes from S901 to S914 in FIG. 13 are similar to those from S701 to S714 in FIG. 11 according to the second embodiment, and will not be described.

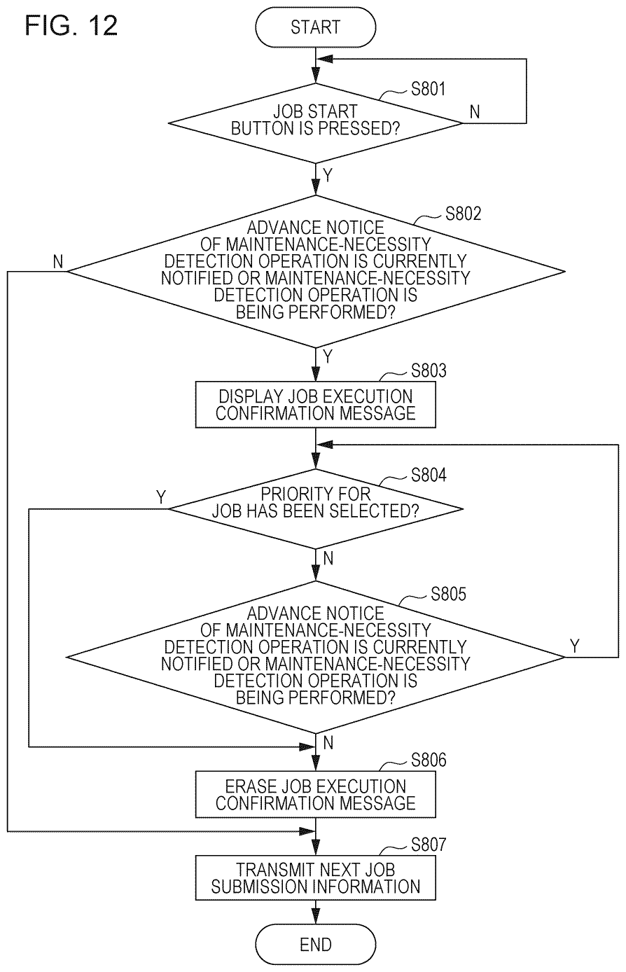

The charge-removal CPU 82 determines whether the maintenance-necessity-detection execution flag stored in the RAM 84 is ON (S914). If the maintenance-necessity-detection execution flag is OFF (S914-N), the charge-removal CPU 82 ends the process. If the maintenance-necessity-detection execution flag is ON (S914-Y), the charge-removal CPU 82 determines whether job submission information including information about whether the next job has been submitted has been received (S915). The job submission information is data transmitted from the image forming apparatus 100 through the communication I/F 87 to the charge removal apparatus 200 when the image forming apparatus 100 receives a job on the basis of the flowchart in FIG. 12 described later.

If submission information of the next job has been received (S915-Y), the charge-removal CPU 82 does not perform a maintenance-necessity detection operation, and ends the control. In other words, when a user submits the next job while the main-body display unit 66 is notifying, in advance, a maintenance-necessity detection operation, and when “Yes” is pressed on the job execution confirmation message on the main-body display unit 66, the maintenance-necessity detection operation is not performed. In other words, when a maintenance-necessity detection operation is skipped, the cumulative time Ts is not cleared.

If submission information of the next job has not been received (S915-N), the charge-removal CPU 82 causes, through the communication I/F 87, the main-body display unit 66 of the main-body CPU 61 to erase the displayed advance notice message of a maintenance-necessity detection operation (S916). The charge-removal CPU 82 performs a maintenance-necessity detection operation (S917), and ends the process. The charge-removal CPU 82 sets the maintenance-necessity-detection execution flag to OFF just before execution of a maintenance-necessity detection operation.

Maintenance-Necessity Detection Operation according to Third Embodiment

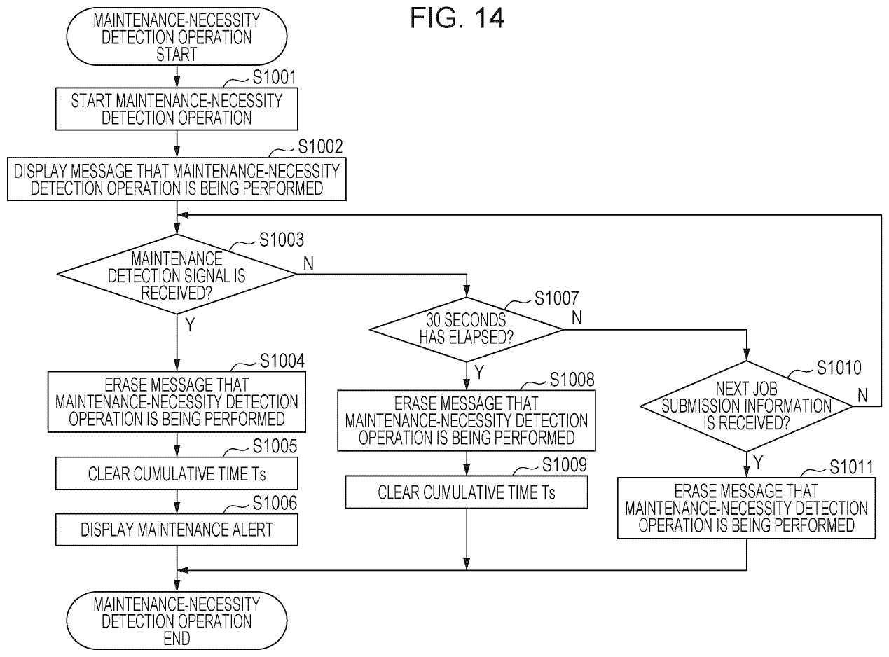

FIG. 14 is a flowchart of a maintenance-necessity detection operation according to the third embodiment. The flowchart in FIG. 14 describes the details of the maintenance-necessity detection operation in S917 in FIG. 13.

The processes from S1001 to S1007 in FIG. 14 are similar to those from S601 to S607 in FIG. 10 according to the first embodiment, and will not be described.

If the charge-removal CPU 82 has not received the maintenance detection signal 95 from the ionizers 52 (S1003-N), the charge-removal CPU 82 determines whether 30 seconds has elapsed since start of the maintenance-necessity detection operation (S1007). If 30 seconds has elapsed without reception of the maintenance detection signal 95 since start of the maintenance-necessity detection operation (S1007-Y), the charge-removal CPU 82 erases, through the communication I/F 87, the message that a maintenance-necessity detection operation is being performed, which is displayed on the main-body display unit 66 (S1008). The charge-removal CPU 82 clears the cumulative time Ts (S1009), and ends the process. In other words, the case in which a predetermined time has elapsed in a state in which the maintenance detection signal 95 remains at the L level indicates that a maintenance-necessity detection operation has been performed for the predetermined time. In this case, cleaning of the ionizers 52 is not necessary. Thus, the charge-removal CPU 82 does not cause the main-body display unit 66 to display a maintenance alert for recommending cleaning of the ionizers, and the screen in FIG. 8A is displayed.

If 30 seconds has not elapsed after start of the maintenance-necessity detection operation (S1007-N), the charge-removal CPU 82 determines whether job submission information including information about whether the next job has been submitted has been received (S1010). The job submission information is data transmitted from the image forming apparatus through the communication I/F 87 to the charge removal apparatus 200 when the image forming apparatus 100 receives a job on the basis of the flowchart in FIG. 12 described later.

If submission information of the next job has not been received (S1010-N), the process returns to S1003.

If submission information of the next job has been received (S1010-Y), the charge-removal CPU 82 erases, through the communication I/F 87, the message, on the main-body display unit 66, that a maintenance-necessity detection operation is being performed (S1011), and ends the process. In other words, when a user submits the next job while the main-body display unit 66 displays the message that a maintenance-necessity detection operation is being performed, and when the user presses “Yes” on the job execution confirmation message on the main-body display unit 66, the maintenance-necessity detection operation is interrupted. If the charge-removal CPU 82 receives next job submission information and interrupts the maintenance-necessity detection operation (S1010-Y), the cumulative time Ts is not cleared.

Therefore, also in the next job, the cumulative time Ts exceeds the threshold. Thus, also in the next job, the maintenance-necessity-detection execution flag will be ON.

Operation of Image Forming Apparatus according to Third Embodiment

FIG. 12 is a flowchart of control performed by the main-body CPU 61 of the image forming apparatus 100.

The main-body CPU 61 waits until a job start button 666 (FIGS. 8A to 8D) on the main-body display unit 66 is pressed (S801-N). At that time, as illustrated in FIGS. 8A to 8D, the main-body display unit 66 of the image forming apparatus 100 displays a message that a print job is ready to be received for execution or a reservation.

If a user presses the job start button 666 on the main-body display unit 66 (S801-Y), the main-body CPU 61 determines whether an advance notice of a maintenance-necessity detection operation is currently notified or a maintenance-necessity detection operation is being performed (S802). Whether an advance notice of a maintenance-necessity detection operation is currently notified is determined on the basis of whether the message (FIG. 8C) of an advance notice of a maintenance-necessity detection operation is currently displayed on the display unit 66. Whether a maintenance-necessity detection operation is being performed is determined on the basis of whether the message (FIG. 8B) that a maintenance-necessity detection operation is being performed is currently displayed on the display unit 66.

If an advance notice of a maintenance-necessity detection operation is not currently notified and a maintenance-necessity detection operation is not being performed (S802-N), the main-body CPU 61 transmits next job submission information to the charge-removal CPU 82 of the charge removal apparatus 200 through the communication I/F 87 (S807), and ends the process. After the next job submission information is transmitted to the charge-removal CPU 82 of the charge removal apparatus 200 (S807), the main-body CPU 61 performs the submitted job.

If an advance notice of a maintenance-necessity detection operation is currently notified or a maintenance-necessity detection operation is being performed (S802-Y), the main-body CPU 61 causes the main-body display unit 66 to display the job execution confirmation message (FIG. 15) (S803). The job execution confirmation message describes that the maintenance-necessity detection operation of the ionizers is to be skipped, and that the submitted job is to be performed. In the job execution confirmation message, the accept button 664 for a user to accept the message is displayed.

The main-body CPU 61 determines whether priority for the job has been selected (S804). Specifically, the main-body CPU 61 determines whether the accept button 664 has been pressed. When the accept button 664, on which “Yes” is displayed, is pressed in the job execution message in FIG. 15, the main-body CPU 61 determines that priority for the job has been selected. When the accept button 664, on which “Yes” is displayed, is not pressed, the main-body CPU 61 determines that priority for the job is not selected.

If the user selects priority for the job (S804-Y), the main-body CPU 61 erases the job execution confirmation message displayed on the main-body display unit 66 (S806). The main-body CPU 61 transmits next job submission information to the charge-removal CPU 82 of the charge removal apparatus 200 through the communication I/F 87 (S807), and ends the process. After the next job submission information is transmitted to the charge-removal CPU 82 of the charge removal apparatus 200 (S807), the main-body CPU 61 performs the submitted job appropriately. Specifically, when a job is being performed, after the running job is completed, the next submitted job is started.

If the user does not select priority for the job (S804-N), the main-body CPU 61 determines whether an advance notice of a maintenance-necessity detection operation is currently notified or a maintenance-necessity detection operation is being performed (S805). If an advance notice of a maintenance-necessity detection operation is currently notified or a maintenance-necessity detection operation is being performed (S805-Y), the process returns to S804. In contrast, if an advance notice of a maintenance-necessity detection operation is not currently notified and a maintenance-necessity detection operation is not being performed (S805-N), the main-body CPU 61 erases the job execution confirmation message displayed on the main-body display unit 66 (S806). The main-body CPU 61 transmits the next job submission information to the charge-removal CPU 82 of the charge removal apparatus 200 through the communication I/F 87 (S807), and ends the process.

After the next job submission information is transmitted to the charge-removal CPU 82 of the charge removal apparatus 200 (S807), the main-body CPU 61 performs the submitted job. That is, until a maintenance-necessity detection operation is completed or “Yes” is pressed on the job execution confirmation message in FIG. 15, the job execution confirmation message is displayed, and submission of the job is pended.

In other words, when the main-body CPU 61 causes the main-body display unit 66 to display the job execution confirmation message, if a user selects priority for the job, the main-body CPU 61 transmits next job submission information to the charge-removal CPU 82, and skips the maintenance-necessity detection operation of the ionizers. In contrast, when the main-body CPU 61 causes the main-body display unit 66 to display the job execution confirmation message, if a user does not select priority for the job, the main-body CPU 61 waits until the maintenance-necessity detection operation of the ionizers is completed.

The main-body display unit 66 may display job execution confirmation messages different between the case in which an advance notice of a maintenance-necessity detection operation is currently notified and the case in which a maintenance-necessity detection operation is being performed. For example, in the case of an advance notice of a maintenance-necessity detection operation, the job execution confirmation message may describe that the maintenance-necessity detection operation will be skipped; in the case where a maintenance-necessity detection operation is being performed, the job execution confirmation message may describe that the maintenance-necessity detection operation will be interrupted. Thus, from a job confirmation message describing that a maintenance-necessity detection operation is being performed, a user may be notified that the maintenance-necessity detection operation has already started.

In the third embodiment, when a job is submitted while an advance notice of a maintenance-necessity detection operation is currently notified or a maintenance-necessity detection operation is being performed, the job execution confirmation message is displayed, and the maintenance-necessity detection operation is prioritized. Alternatively, priority for execution of a job may be set in advance.

Thus, in the third embodiment, when a job is submitted while a message of an advance notice of a maintenance-necessity detection operation is displayed or a message that a maintenance-necessity detection operation is being performed is displayed, the maintenance-necessity detection operation is skipped or interrupted, and a message for confirming whether a job is to be performed is displayed. Thus, the possibility that a user's submission of a job causes unintentional interruption of a maintenance-necessity detection operation may be reduced.

In the third embodiment, the ionizers 52 are used in the noncontact charge-removal unit 58. However, the configuration is not limited to this. Corotrons may be used. In the third embodiment, the contact charge-removal unit 57 applies a voltage to the charge removal roller 50, and the voltage value is set so that the surface potential of a sheet comes close to zero. However, the configuration is not limited to this. The charge removal apparatus 200 supplies a charge to a sheet through the charge removal roller 50 serving as a charge supply member. Thus, the charge removal apparatus 200 also functions as a charge adjustment device which adjusts the charge state of the sheet. The charge adjustment device may be a device which does not necessarily decrease the amounts of charges on a sheet (does not remove charges). For example, in a state in which sheets are stacked after the process by the charge adjustment device, the amounts of charges of surfaces of sheets may be adjusted so that the opposing surfaces of adjacent sheets are electrostatically charged to the same polarity. Specifically, the charge adjustment device applies a voltage to every other one of sheets so that the electrostatic polarity of the sheet surface is reversed. In other words, the voltage applied to the charge supply member is set to a magnitude causing the electrostatic polarity of a sheet surface to be reversed, and the voltage is applied to every other sheet. In this case, the opposing surfaces of adjacent sheets are electrostatically charged to the same polarity, resulting in reduced sticking of sheets due to electrostatic force.

However, the amounts of charges on a sheet after the charge adjustment process performed by the charge adjustment device described above are large. Thus, sheets easily stick to a transport path, which may cause transport failure. To mitigate transport failure of sheets, in the charge adjustment device, the noncontact charge-removal unit 58 may be disposed, for removal of charges on the sheets, downstream of the roller for adjusting charges on the sheets. Also in this case, it is preferable that the noncontact charge-removal unit 58 performs a maintenance-necessity detection operation at appropriate times. Also in the charge adjustment device, the display unit 56 displays a notification that a maintenance-necessity detection operation is being performed, enabling a user to grasp the operation state of the maintenance-necessity detection operation. Thus, the possibility that a user unintentionally interrupts a maintenance-necessity detection operation may be reduced.

In the embodiments described above, the case in which the image forming system is applied to the image forming system 300 employing an electrophotographic method is described. However, the configuration is not limited to this. The image forming system may be applied to an inkjet recording system employing an inkjet recording method.

The present disclosure enables a reduction in possibility that a detection process of detecting whether maintenance of a noncontact charge-removal unit is necessary is unintentionally interrupted.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to Japanese Patent Application No. 2024-220509, which was filed on Dec. 17, 2024 and which is hereby incorporated by reference herein in its entirety.

What is claimed is:

1. An image forming system comprising:
an image forming unit that forms an image on a sheet;
a noncontact charge-removal unit that removes a charge on the sheet, on which the image has been formed, in a noncontact state, the noncontact charge-removal unit including an electrode portion that generates an ion;
a controller that performs a detection process of detecting whether maintenance of the electrode portion is necessary; and
a display unit that indicates that the detection process is being performed.

2. The image forming system according to claim 1, further comprising:
a housing that houses the noncontact charge-removal unit,
wherein the display unit is disposed on an outer surface of the housing.

3. The image forming system according to claim 1,
wherein the controller further controls the noncontact charge-removal unit to perform a charge removal process of removing charges on a plurality of sheets, the plurality of sheets being transported from the image forming unit,
wherein the detection process is performed after the charge removal process.

4. The image forming system according to claim 1,
wherein, in response to submission of a job during execution of the detection process, the display unit indicates, to a user, that the execution of the detection process is to be interrupted and the job is to be performed.

5. The image forming system according to claim 1,
wherein, in response to submission of a job during execution of the detection process, the display unit displays a screen in which a user can select whether the execution of the detection process is to be interrupted.

6. The image forming system according to claim 1,
wherein the display unit provides a notification that the detection process is being performed, and displays a message that indicates that submission of a job is not recommended.

7. The image forming system according to claim 1,
wherein, before execution of the detection process, the display unit displays an advance notice of a start of the detection process.

8. The image forming system according to claim 7,
wherein, after an operating time of the noncontact charge-removal unit exceeds a threshold and before the detection process is performed, the display unit displays the advance notice of the start of the detection process.

9. The image forming system according to claim 1,
wherein, in response to submission of a job while an advance notice of a start of the detection process is displayed by the display unit,
the display unit displays a screen in which a user can select whether the job is to be performed without execution of the detection process.

10. The image forming system according to claim 1, further comprising:
a contact charge-removal unit that is disposed downstream of the image forming unit in a sheet transport direction, and that removes a charge on the sheet in a contact state,
wherein the noncontact charge-removal unit is disposed downstream of the contact charge-removal unit in the sheet transport direction.

11. An image forming apparatus that is connectable to a charge removal apparatus, the charge removal apparatus including a noncontact charge-removal unit and a controller, the noncontact charge-removal unit including an electrode portion that generates an ion, the noncontact charge-removal unit removing a charge on a sheet, on which an image has been formed by an image forming unit, in a noncontact state, and the controller performing a detection process of detecting whether maintenance of the electrode portion is necessary, the image forming apparatus comprising:
the image forming unit; and
a display unit that indicates that the detection process is being performed by the controller.
